(19) United States
(12) Patent Application Publication
(10) Pub. No.: US 2023/0257291 A1
(43) Pub. Date: Aug. 17, 2023

(54) APPARATUS FOR CONTINUOUS HEAT AND PRESSURE PROCESSING OF A FLUID

(71) Applicant: Thomas J. BURKE, Anchorage, AK (US)

(72) Inventor: Thomas J. BURKE, Anchorage, AK (US)

(21) Appl. No.: 17/672,236

(22) Filed: Feb. 15, 2022

(51) Int. Cl. C02F 11/18; C02F 1/04

(52) U.S. Cl. CPC C02F 11/185; C02F 1/043; C02F 2209/02; C02F 2209/40; C02F 2303/04; C02F 2303/10; C02F 2303/14

(57) ABSTRACT

A device for sterilizing fluid waste to render said waste noninfectious, said device comprising a U-shaped conduit means, a pump, and a heating means, wherein the conduit means is oriented vertically so that fluid moving through it is subjected to higher pressures at the bottom of the loop, heat is applied to fluid at the bottom of the loop by the heating means, and the pump moves the fluid through the conduit means at a flow rate that ensures sufficient heat is applied to the fluid for a sufficient period of time.

### BACKGROUND OF THE INVENTION

Fecal waste (human and animal) and more broadly biological waste represents a form of pollution and health risk, but it also represents a potential resource as biological material useful for fertilizer, compost, and potentially other more valuable products.

According to the United Nations, worldwide about 80% of human waste goes into waterways with no treatment at all. According to the World Health Organization there are about 1 million deaths per year (primarily children) caused by infections transmitted by untreated human wastewater. Another 5 million deaths are caused by chronic malnutrition in part caused by endemic diarrheal illnesses associated with untreated sewage. The business of raising agricultural animals over time has shifted towards high density operations producing huge amounts of waste where no natural degradation processes is possible. Treatment for animal waste is largely nonexistent even in advanced countries. In many parts of the world crop irrigation is routinely done with untreated wastewater.

At the same time, in advanced countries human waste is treated to high discharge standard and is generally cleaner than the drinking water available to many of the people in the undeveloped world.

Historically, fecal and other waste was discharged untreated into the nearest waterway. Starting about two centuries ago, the need to protect those waterways as populations grew and the need to protect the next town downstream lead to wastewater treatment. These systems were focused on the quality of water discharged without addressing the larger picture of how biological waste and solid waste were resources or how water was becoming a scarce resource or the fact that sewage treatment accounts for approximately 3% of greenhouse gases emissions. The 3% number is based on sewage that is treated and does not include sewage that is not treated or animal waste which is generally not described to sewage. A more ecologically aware public has led to more stringent discharge standards and more aggressive treatment of wastewater, but all within the same paradigm focusing on the quality of the water discharged.

This paradigm is out of date. In the world where we understand greenhouse gases and global warming we need to consider sewage treatment with entirely different goals. We don’t want to change the biological material in animal waste into methane or carbon dioxide by any kind of sewage treatment or disposal. We want to make use of all the water in the wastewater. We should try to make use of the nutrients (nitrogen and phosphorus) in the wastewater. We want to return all the carbon in animal waste and human waste back to the carbon cycle at its most useful point; this generally means returning it to the soil. The soil is a natural recycling systems of terrestrial animal waste. In the soil the organic molecules do not directly feed plants but feed soil bacteria. Compost and manure are indirectly good for plants because they are good for the soil and the soil bacteria directly. Organic carbon stored in soil is a proximally 3 times that stored in plants. Deforestation, desertification, soil erosion and most modern agriculture gradually deplete carbon from the soil making it less fertile and more prone to drought.

Current state of the art sewage treatment systems use large amounts of energy pumping, mixing, and aerating sewage in order to promote bacterial digestion of the biological oxygen demand and chemical oxygen demand, turning it into carbon dioxide. This is essentially an organic incineration process. The systems also have a large energy demands for drying the solid components. What isn’t turned into carbon dioxide is typically sent to a landfill where it becomes methane and carbon dioxide. This is a paradigm of disposal rather than recycling. These systems do not specifically sterilize waste but rather reduce bacteria and pathogens to levels that meet regulatory standards. While this is important for municipal waste treatment, it is overkill for other uses, such as agricultural waste management. If biological waste can be effectively and efficiently sterilized only to a degree that would render it noninfectious, it could be potentially valuable for use for other purposes, rather than merely being discharged into waterways.

The present invention does not replace municipal wastewater treatment plants. It does, however, completely address infectious disease risk and it does this inexpensively and with a much simpler process than standard sewage treatment.

In addition to sterilizing sewage, the process described herein changes the physical characteristics of the waste in significant ways that opens the door for alternative paradigm in waste disposal.

Heat treatment causes lysis of bacterial cell walls. This changes a fluid that is mostly particulates in suspension into a fluid that is mostly organic chemicals in solution. This also eliminates most of the odor. Heat treatment will cause lysis of vegetable matter cell walls as well. This will mean that the solids are smaller, softer, and have lower viscosity. The process of heating causes hydrolysis of some of the protein and carbohydrates polymers. These changes in the physical characteristics of the solid components of waste, particularly if used in combination with some grinding process to reduce particle size, can produce a suspension of fine particulate matter with high osmolality rather than a sticky sludge. The resultant output would be sterile, have less odor, be less sticky, be easily suspended and dissolved in water, be easily digested, and be easily transported. This allows a new paradigm where the water, the organic matter, the nitrogen, and the phosphorus are all returned to normal biological cycles that they came from. The soil is improved. The land is irrigated. The plants are fertilized. And the maximum value is retained. This paradigm of recycling carbon addresses greenhouse gases and global warming in a way that no prior sewage treatment as achieved.

### Heat Treatment Terms

The necessary factors to achieve biological sterilization through heat are 1) temperature, 2) time, and 3) pressure. To sterilize biological material, it needs to be heated to a sufficient temperature for a sufficient period of time. In order to achieve those goals without simply boiling the material it needs to be kept under pressure. The higher the pressure, the higher the obtainable temperature, and thus the less time needed to achieve sterilization.

Heat treatment to reduce infection risk is commonly used in commercial food production settings in the form of pasteurization. This has long used counter current heat exchange to reduce cost. Pasteurization typically involves a target temperature between 70 and 100° C. As such, this method does not require pressurization because of the temperatures used. This is effective at markedly reducing or eliminating most but not all bacteria, though it will not generally kill spores. This is most commonly used in brewing and dairy foods.

Sludge pasteurization is a term used to describe heat sterilization of animal waste solids / sludge in order to make fertilizer. This is standard technology using pressure and heat similar to the present invention. The degree of sterilization needed to produce fertilizer is dependent on the regulatory environment. Because of the energy cost this is not applied to the effluent portion of waste treatment or to human waste treatment. The cost of this process is justified by a salable product of manure/fertilizer. Even more intensive heating is sometimes applied to sludge in processes known as sludge stabilization requiring temperatures as high as 200° C. and pressures as high as 15 atm.

Hydrothermal Liquefaction is a term used to describe treating biological waste with heat and pressure to create hydrocarbon fuels described as bio-oil or bio-fuel. This requires treatment at much higher temperatures (250-1000° C.) with accompanying high pressures.

Heat sterilization (autoclaving) is a standard used for medical processing to prevent transmission of infection. This is a far more stringent standard than what is used for waste processing or food processing in general. It is used here as a gold standard for what would be the most complete processing against infectious risks. Most bacteria would be killed by simple pasteurization with temperatures not exceeding 70° C. Heat resistant bacteria and spore forming bacteria are known to be killed by the standards described as sterilization/autoclaving. Botulism is the classic example of bacteria that survive high heat without pressure. Standard medical sterilization techniques would require a temperature of 121° C. for 30 minutes or 132° C. for 4 minutes. The higher the pressure the higher the temperature that can be achieved without boiling and the quicker the biological effect is achieved (e.g., at 2 atm of pressure a temperature of 121° C. can be achieved, while at 3 atm of pressure a temperature of 134° C. can be achieved and at 4 atm of pressure a temperature of 144° C. can be achieved).

Since medical heat sterilization requires both heat and pressure, these are generally done as a batch processing procedure. Continuous processing has been used in pasteurization with counter current heat recovery.

It is thus shown that there is a need for an efficient, low cost method for sterilizing waste to render it noninfectious yet retain valuable nutrients for productive uses, rather than simply disposal.

Therefore, it is an object of the present invention to provide an efficient, low cost method for sterilizing waste to render it noninfectious yet retain valuable nutrients for productive uses.

It is a further object of the present invention to provide an apparatus for use in a method for sterilizing waste to render it noninfectious yet retain valuable nutrients for productive uses.

Other objects of the present invention will be readily apparent from the description that follows.

### SUMMARY OF THE INVENTION

The present invention proposes an efficient way to heat sterilize biological waste to render it noninfectious and useful. The present invention proposes a mechanism that is low tech and high throughput (scalable), making it applicable to low resource settings and commercial applications where cost has historically prevented appropriate waste treatment. The basic invention is a counter current fluid loop. In this loop the parameters being exchanged in the counter current mechanism are both the temperature of the fluid and the pressure of the fluid. Counter current heat exchangers are standard technology but a system that exchanges heat and at the same time pressurizes and depressurizes the fluid is not seen in the prior art.

As opposed to current treatment methodologies, the present invention does not require large energy investments and offers a significant opportunity for reducing carbon emissions. In considering the costs of heat sterilization, the energy cost must be compared to the costs of other sewage treatment options.

The present invention proposes heat sterilization as a continuous procedure using the height of a column of water to produce the needed pressure. Since the pressure is achieved by a height of a column of water rather than any sealed container, the complexity, the cost, and the hazards associated with pressurizing and depressurizing any such system are avoided.

The basic elements of the present invention are 1) achieving pressure on the fluid to be treated by subjecting it to a vertical drop, 2) adding heat energy to the pressurized fluid, and 3) controlling the time that the fluid is subjected to pressure and heat to achieve sterilization.

### #1 Pressure From Vertical Drop

The invention in its simplest form consists of a single pipe or channel forming a long U shaped loop oriented vertically and extending for a vertical drop sufficient to achieve the desired pressure within the column of fluid (an exemplary design would have a vertical drop of 20-30 m). The fluid to be processed enters the loop at the top of one leg (referred to herein as the “down leg” indicating the direction of flow) and then reverses direction at the bottom of the loop and exits at the top of the other leg (referred to herein as the “up leg”). The fluid begins at a baseline pressure (typically but not specifically atmospheric) at the top of the loop before entering the down leg of the loop. As it moves downward within the down leg of the loop, the fluid is subjected to ever increasing pressures, reaching a significantly higher maximum pressure at the bottom of the loop, as a result of the vertical drop of the column of fluid above it. As the fluid rises through the up leg of the loop, the pressure of the fluid decreases until it returns to the baseline upon exit of the up leg of the loop.

This simple mechanism produces elevated pressures without anything more complex than a single U-shaped pipe and gravity, and without any addition of work (energy).

### #2 Application of Heat

The second basic element of the invention is the addition of heat to the system at the bottom of the loop, combined with a countercurrent heat exchange function transferring heat from fluid within the up leg of the loop to fluid within the down leg of the loop.

Each leg of the U loop is in close proximity to the other leg, such that heat is transferred from one side to the other. At the bottom of the loop the temperature of the fluid can be raised significantly above 100° C. because the pressure within the column is above 1 atm and thus the local boiling point of the fluid is elevated.

The most significant cost for a heat sterilization process is typically the energy needed to raise the temperature of the fluid to be treated. In the configuration of the present invention herein described, the heat energy added to the system is minimized. This is achieved by the heat being added to the fluid at the bottom of the loop. The heated fluid then moves upward from the bottom of the loop through the up leg of the loop. Since the up leg of the loop is arranged as a counter current heat exchanger with the down leg of the loop, the excess heat energy transfers from the upwardly moving fluid in the up leg of the loop to the downwardly moving fluid in the down leg of the loop (heat moving down a temperature gradient). This heat exchange function raises the temperature of the fluid moving downward in the down leg of the loop without having to provide addition external heat energy to the fluid; it also is a means of recovering excess heat energy from the fluid rising upward through the up leg of the loop. The end result is that a relatively small amount of direct heat energy applied to the fluid at the bottom of the loop is sufficient to achieve the desired temperature. The fluid exiting the top of the up leg would approximate the temperature of the fluid entering the top of the down leg.

Like all heat exchangers, the efficiency of this process would be dependent on surface area and flow rate and the heat conduction between the two columns of fluid. In a system with sufficient length and slow flow nearly all of the heat needed to raise the temperature could be recovered.

From the forgoing, the following rate limiting factors are noted: the greater the vertical drop of the loop, the higher the pressure at the bottom of the loop; increased pressure allows higher temperature at the bottom of loop without boiling; higher temperature allows shorter sterilization time (greater biological effect) and greater throughput; and higher temperature allows larger temperature gradients across heat exchange interfaces, increasing heat transfer efficiency. This interaction between temperature, pressure, and biological effect means that the throughput of a sufficiently high pressure system will be limited by the heat transfer in the counter current and not by the sterilization time requirement (so, for example. a 100 m drop could have a peak temperature of 144° C. requiring less than 1 minute of total sterilization time).

Adding heat to an inert substance like water could be considered in purely thermodynamic terms and reasonably assumed that nearly all the energy was conserved. However, since this is meant to sterilize biological material some heat will be consumed as it performs work altering the biological / chemical components of the fluid. The work of this heat addition is not an inefficiency and cannot be eliminated since that is the purpose of the process. Ideally the energy would come from non-fossil sources. Waste treatment systems can produce energy from methane or the burning of solid waste.

### #3 Controlling Fluid Flow Rate

As noted above, once the flow achieves the desired temperature gradient across the counter current heat exchange, fluid can be moved at a relatively quick rate through the system. However, upon startup, there is no heat energy in the fluid located in the up leg of the loop, and thus no transfer by heat exchange to the fluid located in the down leg of the loop. Thus the initial fluid reaching the bottom of the loop will be colder than the fluid after the cycle has been running. This requires a longer application of heat to the fluid at the bottom of the loop, which is achieved by slowing down the flow of the fluid. Thus, this third basic element of the invention is a means of controlling the flow of the fluid. Initial fluid flows are slower, then are increased as the system comes up to working temperatures. Additionally, flow control is used when the availability of heat energy to be applied to the bottom of the loop is variable. When less heat energy is available to be provided, the flow is slowed, and when more heat energy is available to be provided, the flow is increased.

In addition to the basic elements of the invention as described above, there are other aspects of the present invention that increase its utility.

### #4 The Invention Can Be Easily Cleaned

The basic design of the present invention assumes two things related to the ability to clean the system. Since the system is adding heat to a biological material, biological material potentially will accumulate on the interior walls of the U-shaped loop (fouling) and therefore will need to be periodically cleaned. Fouling would impair the heat transfer process.

If the down leg and the up leg of the loop are tubular (round cross section), then a brush or bore system could be fed into an opening at the top of each leg and then moved through the entire length of each leg in order to perform cleaning functions. If the legs are largely straight this would facilitate the ability to clean a system having significant length. The basic configuration described herein allows cleaning devices to enter the loop at the top where it is not pressurized and clean the entire length of either the up leg or the down leg of the loop without contaminating the sterile output or emptying the system or turning the system off. Existing counter current heat exchangers cannot address the issue of fouling to the same degree. The linear design of the present invention and the ability to access the system at an unpressurized point is not seen in the prior art.

### #5 Two Stage Heat Exchanger

The present invention can divide the heat exchanger into 2 stages: one pressurized and one unpressurized. The required pressure can be achieved with a vertical drop of 20-30 m. The increased pressure is only needed when the temperature of the working fluid is near or above the boiling point of the fluid. This allows the separation of the heat exchange process into 2 segments. The first segment does not require pressurization and is used when processing the fluid at temperatures significantly below boiling point, and the second segment is pressurized by gravity where the working fluid is near or above its boiling point. This is illustrated as a two-step process with one heat exchanger that does not involve vertical drop (not pressurized) and the second pressurized heat exchanger that does require a vertical drop.

### #6 (Alternative Embodiment) Parallel Processing (Invention Consists of Any Number of Loops)

The basic invention is described as having a single U shaped loop. However, heat transfer would be enhanced by having multiple parallel loops (each using a narrower pipe), thereby increasing the surface area exposed to the working fluid. Whether the system has a single loop or multiple loops, each loop would need to be regulated for the rate of flow in order to assure complete sterilization.

Three potential strategies to enhance heat transfer, both low tech and high tech, are herewith described:

### A. Direct Heat Conduction

A number of loops, each made of corrosion resistant steel pipe, are bundled together and then cast in a metal with high heat conductivity, such as aluminum. Optimally, this would be configured to maximize proximity of up legs to down legs.

### B. Complex Heat Pipe

A number of loops, each made of corrosion resistant steel pipe, are bundled together. The loops pass through a series of separate pressurized (sealed) chambers. Each chamber has a volatile fluid added to the space, allowing it to function as a heat pipe with the heat from the up legs boiling the volatile fluid and the down legs condensing the resulting vapor, thereby transferring heat from up leg to down leg pipes. Such a system transfers heat by gas pressure rather than by conduction or convection. The temperature gradient between the two legs would then depend primarily on the gradient across each pipe wall. A system using multiple small caliber pipes rather than a small number of larger pipes increases surface area between pipe wall and fluid and allows thinner pipe walls. It would also assure that there was no significant distance between any portion of the treated fluid and a pipe wall. Such a system would be complex to construct but would improve efficiency. Heat pipes are a mature technology requiring little to no maintenance and a re common to the solar power industry. The heat transport capacity of a heat pipe far exceeds that of any conductor allowing it to be used as a substitute for proximity (but not surface area) between the hot and cold legs the system.

### C. Simple Heat Pipe

A combination of the two systems noted above could contain a bundle of down legs (heat receivers) linked to a bundle of up legs (heat releasers). Each bundle could be encased in a heat conductor and the two bundles could be cross-linked by conventional heat pipes (simple tubular shapes) to create a high capacity heat transfer mechanism between the two sides.

### #7 (Alternative Embodiment) Common Reservoir

In a system of multiple parallel loops, each loop could be independent (as described above). An alternative embodiment of the invention could have a common reservoir replacing the individual U-bends at the bottom of the loops. A common reservoir at the bottom would have potential benefits in terms of trapping solids, mixing, grinding, or a single point of heat addition. In such a system with a common reservoir, the flow in the down legs as well as the flow in the up legs would need to be regulated to assure sterilization time.

### #8 (Alternative Embodiment) Intermittent Flow

An additional alternative would be a system where flow was intermittent. This would allow a very specific time and temperature calculation. This would in some ways resemble batch processing. Such a system that had longer heat at times would require less surface area per unit volume and could be appropriate/comparable to sludge stabilization by heat.

### Economy of Scale: Critical Mass // Thermal Mass // Insulation

The key to the process described above is adding sufficient heat to sterilize the material which requires an energy source which implies an energy cost. The value of the invention lies in its ability to minimize the energy cost.

The key then becomes heat loss to the environment versus heat transfer between the two legs of the countercurrent loop. This is dependent both on insulation and on the relationship of volume to surface area. The prior section addressed the heat transfer between the down leg and the up leg but remaining within the system. This section addresses heat loss / heat leaving the system.

Since the length of the pipe/loop is essential for the pressurization function and the invention proposes straight and mostly vertical pipes to allow for cleaning, the basic shape of the device will be a bundle of elongated U shaped pipes in a heat conducting matrix enclosed in a long insulated cylinder. The length of the cylinder will be the primary determinant of surface area and therefore potential energy loss. The geometric factor determining heat efficiency for any length then becomes the ratio of perimeter to cross sectional area of the cylinder. The larger the better (more thermally efficient).

### Critical Mass

The critical mass approach is the most elegant solution to the size and efficiency problem. A number of devices could be packed vertically parallel to each other and in very close proximity (like the bundled fuel rods of a nuclear pile) overcoming the problem of heat loss to the environment. While any one device (loop) would have a large surface area and a large heat loss, each additional device would add a smaller amount of heat loss. While the throughput of the system would be proportional to the number of loops, the surface area, and therefore the heat loss, would be proportional to the square root of the number of loops. Very large systems, meaning systems with large numbers of loops providing parallel processing, would be more efficient. However, there are practical limitations to the strategy. The device would be at least 20 m in length and potentially significantly longer. The device would need to be constructed of highly heat conductive materials which would likely be metal and therefore heavy. An optimal configuration for the device would then be a very heavy, long cylinder with all inputs and outputs at the top end. Transporting such a system or building it on-site would have size related engineering challenges.

### Thermal Mass

Ideally the device would be surrounded by an insulating material and the insulating material would also function as thermal mass retaining that lost heat. This can be readily achieved by burying the device. Such a device would lose heat to the environment (the surrounding earth) but as that earth is warmed the losses would gradually diminish. Multiple devices could be placed in close proximity to share this thermal mass effect. Placing the device in a near vertical orientation within the earth (such as in a well) also has the advantage of accommodating the length of the device without the need for a significant supporting structure. Since each loop of the device is a closed system that is only accessed from the top there would be no need to access the bottom of the device after it is built/installed. The exception to this is the need for heat addition at the bottom of the loop. Providing heat to the bottom of a well creates technical challenges but not barriers.

### Insulation

Systems that do not have sufficient scale to take advantage of critical mass or thermal mass would need to rely on highly effective insulation. Fortunately, the shape of the device is very much the same as the shape of a thermos bottle. The container to be insulated is a vertical cylinder. From an engineering point of view, it is easy to hang a vertical cylinder (the device) inside of a second, slightly larger vertical cylinder and then evacuate the airspace between the two. In a vacuum insulation system most of the escaping heat is at the point of solid connection (the neck) at the top of the thermos. For this invention, the temperature difference is maximal at the bottom of the cylinder and significantly less at the top. This factor, along with the significant length of the device, would make the heat loss associated with the top of cylinder minor. Vacuum insulation is a proven and relatively inexpensive technology that has long been used for liquefied gas transfer and storage. Vacuum insulation is at least 20 times more efficient per unit distance (thickness) than other forms of insulation. The simple shape of the device allows a vacuum container that can withstand the 1 atm pressure. Other countercurrent systems would be more compact but would have more complex shapes that would not easily be addressed by a vacuum container system. In addition, the fact that this countercurrent device only needs to be accessed from the top while the heat is provided at the bottom means that the insulation system can be put in place and never touched again. This allows strategies for insulation and thermal mass that could not be applied to any other heat exchanger system, including placing the device in a shaft or a well below ground. All other systems would need some kind of disassembly for maintenance or cleaning. While the option of vacuum insulation is particularly appealing for this device, other forms of insulation would also be appropriate but would not have the same efficiency of space.

The determinants of heat loss to the exterior are (i) temperature gradient, (ii) surface area, and (iii) insulation. Efficiency is the ratio of work done to heat lost. In this device, the work done is directly proportional to the volume of the device. The specific and peculiar shape of the device, and in particular its length, are part of the invention. The length of the loop increases the surface area significantly, an order of magnitude compared with other heat exchange systems. Since the length of the device is a given, we can substitute the circumference of the device for the surface area and we can substitute the cross-sectional area of the device for the volume. This leads to the following relationships: (a) work done is proportional to the number of loops, (b) heat loss is proportional to the surface area or the circumference of the device, (c) circumference is proportional to the square root of the number of loops, and (d) efficiency is the work done divided by the heat lost. Algebraic substitution of these relationships shows that the efficiency is proportional to the number of loops divided by the square root of the number of loops. A system with one loop would therefore have an efficiency of one. A system with 100 loops would have an efficiency of 10. A system with 1000 loops would have an efficiency of 32 (and a 97% reduction in the heat lost by each loop). Another determinant of heat loss would be insulation. Standard insulation can reduce heat loss by 90 to 99%. Vacuum insulation can reduce heat loss by even more. Thermal mass is slightly different than insulation alone. A system that was placed in the earth and had a gradient of 100° between the device and the surrounding earth would lose heat rapidly. However, as the surrounding earth warmed up and the heat was retained, that gradient would rapidly decrease to not 100° but 10°, and over time would continue to decrease resulting in a temperature gradient potentially just a few percent of the original gradient. In summary, the length of the device increases surface area by an order of magnitude compared to other heat exchange systems, standard insulation can reduce heat loss by at least one order of magnitude, vacuum insulation can reduce heat loss by one to two orders of magnitude, thermal mass insulation can also reduce heat loss by at least one order of magnitude, and critical mass or parallel processing can also reduce heat loss by at least one order of magnitude. All of these strategies can be used together. If applied appropriately the heat lost directly from the device would be very small and the primary point of heat loss from the system would be the sterile fluid exiting the system warmer than the unsterile fluid entering the system. Systems of almost any size could be constructed with very high efficiency.

Other systems for sterilizing sewage will have the cost and complexly associated with pressurizing and depressurizing the working fluid. This system does not have those costs or complexity.

The inventions advantages are based on its shape including low tech pressurization and ease of cleaning. This same shape has disadvantages both in length and requiring vertical placement and having a large surface area. Strategies to overcome these disadvantages are herein provided, allowing construction of a system that can heat sterilize animal waste with greater efficiency than any of the prior art.

### Other Uses for the Device

Any chemical process requiring both heat and pressure could use this device to simplify creating those conditions. Simple examples would be Cracking hydrocarbons as part of the oil refining process (500° C. and 70 Bar) or Hydrothermal Processing of bio-waste to produce hydrocarbon fuels (350° C. and 200 Bar). While the length that would be required to produce these pressures by gravity are significant they are quite achievable within existing oil and gas wells.

Very long loops could produce very high pressure allowing potential supercritical temperatures.

Very long loops could use geothermal energy as a heat source.

Long loops for more extreme conditions would require ground/well placement.

A well that was 1000 meters deep at a location that had a geothermal gradient of 50° C. per 100 m (a geothermal hotspot) could produce conditions of 100 Bar and 500° C. needed to crack hydrocarbons for refining without an additional energy source.

The basic invention describes a single loop for the treatment of waste. It would be practical to have a conduit that added substances at the bottom of the loop where there is pressure and heat for chemical reaction. Acid or strong base added at this location could be used to hydrolyzed polymers.

Steam could be directly added to the working fluid as a way to deliver heat.

### Uses for Treated Fluid Wastes

Any biological waste will be a mixture. The largest portion will simply be water. Most sewage treatment systems have an initial separation or clarification step (primary treatment) to separate solids or sludge from liquid or effluent. The effluent will typically be 80 to 90% of the volume and the sludge component will contain 80-90% of the biological material. The biological portion of sewage is primarily made up of fecal matter, urine, and paper. All sewage treatment systems must remove some trash and grit. Depending on the source of the biological material, the ratio of solids to water could be quite variable. The characteristics of the solid output after heating depends on the chemical makeup of the input. Solid waste from cattle (a true ruminant animal) could have almost no bulky solids after treatment. Human waste that includes toilet paper (undigested cellulose) would have less alteration of the solid component by heating.

In terms of the present invention, the heat sterilization process could be applied to effluent. It could also be applied to sludge. It would also be possible to sterilize the sewage without separation. If sterilization is applied first, the sewage can still be separated afterwards. Sewage that is mixed and then sterilized can then be separated by flotation rather than settling. These decisions will be based on the eventual output desired.

Following is a list, from worst case scenario to best case scenario, of the possible final disposition of treated human and animal waste.
1. Untreated fecal waste: Human health hazard, contamination of food, water or land. Infectious
2. Partially treated waste: Environmental hazard, contamination of waterways or land areas with nitrogen, phosphorus, and decomposing biologic material. Disruptive to ecosystems.
3. Fully processed waste/Carbon dioxide hazard: Dry sewage sludge is 30-50% carbon by weight. This means that each ton of sewage sludge will be equivalent to 1.5 tons of carbon dioxide in the air.
   a. Incineration (CO₂ + soot)
   b. Complete microbiological conversion to CO₂
   c. Carbon dioxide produced and energy dollars spent generating electricity to process waste
4. Landfill/greenhouse gases hazard producing methane and carbon dioxide: Ideally, landfill methane is burned for energy production, but in most settings this is implemented only partially or not at all. This results in most of the carbon becoming methane which is a far more potent greenhouse gas. While the methane will eventually degrade into carbon dioxide, the greenhouse effect is much greater than carbon dioxide alone, particularly in the short run.
5. Irrigation
6. Soil conditioning as fertilizer or compost
7. Substrate for producing methane, alcohol, fungus, invertebrates, hydroponics, aquaculture
8. Additive to animal feed

The first 4 dispositions listed above are clear and obvious mistakes environmentally, economically, and socially. These are the outcomes when sewage is either not treated or when sewage is treated but biological value is not considered. These first 4 dispositions are also the most expensive.

Dispositions 5 through 8 represent outcomes of increasing economic value. They are not mutually exclusive. These are difficult to achieve if the material is considered toxic, noxious, or infectious. Sterilization overcomes these barriers.

### Considerations of Liquid/Effluent Output

After primary treatment using the methods and device disclosed above, the liquid or effluent component of waste could be used as irrigation. The degree of treatment of the effluent before using it as irrigation depends on the target land to be irrigated. Total fluid discharge from municipal wastewater treatment systems is orders of magnitude less than the volume of water needed for agricultural irrigation. Some municipalities could discharge their entire wastewater output to irrigate just their golf courses. Irrigating a local park with something that smells like sewage would be unacceptable, however, so a significant amount of treatment would be needed (enough to eliminate infection risk and odor). Complete treatment, though, to the level needed to discharge into a public waterway, would be unnecessary and inappropriate for water used for irrigation. The most difficult and expensive steps in wastewater treatment are nutrient removal. This involves removing the nitrogen and phosphorus from the wastewater. On the other hand, nitrogen and phosphorus are exactly what is used to fertilize lawns. Using municipal water which has been treated to drinking water standards, including the application of fluoridation and chlorination, to irrigate lawns or golf courses would be wasteful and inappropriate. Instead using sterilized wastewater processed by the present invention results in the irrigated land receiving both water and fertilizer, and the final steps of wastewater treatment would be accomplished as a normal biological function of the irrigated soil. Currently, communities do not have two water supplies, one for drinking water and one for irrigation, but when considering the treatment of wastewater, it would be beneficial both environmentally and economically to connect sufficiently treated discharge wastewater with large irrigation consumers and never discharge treated wastewater into waterways.

Like any generalization this is something of an oversimplification, but the economics and the biology of this option are a clear win-win situation.

In addition to irrigation
Sterile effluent could be added directly to normal animal feed.
Sterile effluent could be used for hydroponic farming or aquaculture.
Sterile effluent could be used as feedstock for the fermentation producing alcohol or methane.
Sterile effluent could be used as this feedstock for other monocultures.

### Considerations of Solids/Sludge Output

Solids/sludge will be the great majority of the biological material, if not the volume, in any sewage processing system. This will almost always require some form of processing. There is no environmentally acceptable large-scale use for untreated solid animal or human waste. (Not that it hasn’t been tried. Sewage farming was in early predecessor of modern sewage treatment. In such a system raw sewage was spread on farm fields. This worked well. These farms were quite productive. However, such systems could become overwhelmed and anaerobic or lead to contaminated ground water or runoff.)

There are two significant differences between human waste and animal waste. The first is that animal waste can be collected with fewer contaminants. The second is that human waste contains much more water. Sewage systems combine water from many domestic sources such as showers and sometimes storm water. This water is essential for transporting the human waste to treatment sites. The solid components of animal waste can be used for compost or fertilizer for food production. Human waste, in addition to having a larger component of water, will also contain toilet paper and other household wastes such as detergents, personal hygiene products, medications, and potentially more toxic substances such as solvents. Therefore, separating effluent from solids is more important in managing human waste, at least that collected by standard municipal sewer systems.

Finding a commercial use for processed human waste is more problematic because of the other contaminants in the waste stream. More important than the contaminants in the waste stream is the public acceptance of the use of human sewage in food production. Most but not all the contaminants in human waste could be treated by standard methods and composting. An appropriately tested and regulated recycling of human waste for fertilizer/compost may be perfectly safe but persuading the public of that may be impossible. A significant part of the solid waste from sewage treatment is currently used for fertilizer though the public is largely unaware if it. There is, however, a better alternative. A significant amount of agricultural production is for non-food crops. This includes fiber production, landscaping, and biofuels. Fiber production includes timber, cotton, flax, and hemp. There is no reasonable objection to thinking that human waste which might contain residual hormones or drugs was used to improve the soil for growing timber or cotton. The amount of agricultural land committed to these crops far exceeds the potential supply of treated human and animal waste (more than 10% of all cultivated land). Industries for using sewage sludge or bio solids for agriculture are well-established. These are driven by efforts to reduce the cost of disposal of the solid elements (landfill fees) and the markets are small.

### Liquid Manure

One of the largest cost in sewage treatment is in reducing the volume of the solid elements, or dewatering. Sludge is dewatered to create a more easily transported form for fertilizer or compost, or “biosolids”. The odor of raw sludge requires that this be done by expensive industrial processes. This is a significant economic mistake. Sewage sludge can be much more easily transported and utilized in a liquid form saving a tremendous amount of energy and money. The energy cost of dewatering and drying far exceeds the energy cost of heat sterilizing. This alternative, however, involves moving a large volume (high water content) of sewage sludge away from a treatment facility.

To deliver the liquid sludge to the appropriate agricultural market requires bulk transport in liquid form. Bulk rail transport is approximately one third the cost per ton per mile of trucking transport. Pipeline transport and barge transport is cheaper still. Sewage sludge pipelines already exists. Consider a pipeline leaving all of the sewage treatment facilities in southern California taking that liquid sludge to a composting facility in the nearby desert where space, dry conditions, and sparse local population made composting a welcome industry. That is far less than the cost of processing the waste to remove the water. No community wants to receive somebody else’s sewage. If the sewage is sterile and has reduced odor that would be an improvement and make the sewage more acceptable. Liquid sludge can be directly applied to farm fields and then tilled into the soil. Equipment and technology already exists to inject liquefied manure into the subsoils. These processes fix the sludge in place and prevent runoff. Liquid sludge can be added to compost with the appropriate turning or mixing which again fixes the sludge in place and prevents runoff. As noted in the previous section, the effluent portion of sewage treatment could easily be used for irrigation. The changes in physical characteristics of sludge that are induced by heat treatment would potentially allow the sludge component of human and animal waste to be applied to agricultural land using standard irrigation equipment. With some dilution, the fine particulate nature and low-viscosity of the output could easily be accommodated in standard commercial irrigation equipment. Using a common standard technology such as pivot irrigation would allow the biological oxygen demand of treated sewage sludge to be managed and spread over a sufficient area of land to avoid the problems encountered by sewage farming. The best way to address the water content of sewage sludge is by adding it to soil or compost rather than any other drying or dewatering process.

For recycling animal waste, the natural pathway is soil. Soil (and compost) will do all of the same biological steps as waste treatment but will do it over a larger area and over a longer period of time. Soil will also turn the organic component of sewage into the organic (microbiological) component of soil, providing nutrients for plants and retaining water, reducing the need for irrigation and fertilizer and making the land drought resistant. This pathway always costs less and retains more value and produces less CO₂. Doing this successfully requires first eliminating the infectious risk and odor problems and then spreading the waste in such a way that it doesn’t become anaerobic or develop runoff issues.

Recycling systems are typically only marginally effective. While plastic recycling has been a failure or potentially primarily a long-term con, recycling of fiber products/paper/cardboard is a very robust system. By this it is not meant the recycling of paper to make more paper (that strategy has limited success). Rather, it is the composting of paper and fiber products. This is already the mainstay of recycling in some locations, most notably Canada. A large part of what enters landfills is potentially compostable material such as yard waste, logging waste, food processing waste, and all the cardboard and paper products and packaging that is thrown away. These are high in cellulose and low in nitrogen and phosphorus. Mixing these with animal waste (sewage sludge) would absorb the water from the sewage sludge and increase the biological activity of the compost. All of this could be returned to agricultural soils. Some for food production and all for fiber production. Such a strategy would significantly reduce solid waste for landfills or incineration, reduce carbon dioxide production, enhance the productivity of agricultural land, and reduce the need for chemical fertilizer and irrigation. A community that composted solid waste mixed with animal waste and prohibited durable toxins from being used in products bound for composting could finally approach the goal of a recycling program that both was cost-effective and actually environmentally beneficial.

Land use for agriculture has generally reduced the amount of organic matter in the soil, decreasing soil productivity. This long-term loss of carbon is a significant component of global warming. Returning organic carbon to the soil will make land more productive and more drought resistant. Long-term efforts to address climate change will eventually focus on reforestation, avoiding desertification, and using soil for carbon sequestration. These goals will require that we look at every bit of organic waste and figure out how to return it to the soil. This will require that we stop thinking of animal waste is a toxic substance and instead look at it as a resource, and that will be easier to do when it is been sterilized.

### Feedstock: Uses Beyond Soil

Yeast in bread and beer or Lactobacillus in yogurt are examples of monocultures. Similarly, to grow mushrooms, bovine waste is sterilized and then the fungus is added and grown as a monoculture. These are situations where we can design a product based on a microorganism and that microorganism can thrive because it does not have competition from other microorganisms. It requires a sterile substrate. Sewage is not a sterile substrate. We can harvest the product of microorganisms in sewage such as methane but only a very small part of the biological material can be turned into methane. In the setting where we do not choose the microorganism we do not get to manage the product. Biotechnology now can produce microorganisms with very specific output products. Everything from ethanol in beer to human insulin. Monocultures could include bacteria, yeast, fungus, invertebrates like insects and worms, as well as combinations of selected organisms that could work synergistically. All of these have the potential for producing products useful for purposes beyond simple compost or fertilizer. These include fuels, such as ethanol, and animal feed. The highest potential economic value for animal waste would be turning it into palatable supplements to animal feed.

The output of the present invention would be a sterile and mostly liquid. It would contain a large amount of biological material. It would not stay sterile, however. Any bacteria that come in contact with this output would likely begin to grow, decomposing the already partly decomposed biological material. The goal of any system would be to control which bacteria start growing on this substrate. Any microorganism that is added immediately and in large numbers (the inoculation) will determine the characteristics of this biological growth. Adding a bacterium that underwent anaerobic metabolism to produce ethanol or methanol or acetic acid would grow until such time as those products stopped the growth of all microorganisms within the system. These fermentation processes have been used for food preservation and can be applied here to simply preserve the output. Anaerobic metabolism to produce alcohol and acetic acid generally starts with simple sugars. This substrate is unlikely to have a large fraction of simple sugars and may not be able to produce alcohol as an industrial product in the way grain feedstock can.

Consider sterilized sewage sludge with a large inoculum of a bacterium that produced acetic acid being loaded into a rail tanker car which was then sealed and anaerobic. Transportation would agitate the mixture. At delivery the product would be pickled (acidic), sterile, partially treated sewage sludge. The acidity acts as a preservative by stopping the growth of microorganisms but would in no way compromise its value when it enters an aerobic environment and was mixed with soil or compost. Adding a large inoculum of soil bacteria and then aerating the liquid will jumpstart the composting process and reduce fecal odor. In organic farming, an inoculum of soil bacteria is call compost tea or worm castings.

Mushrooms are the easiest example of making food from animal waste without an intermediate plant step. Mushrooms could be an excellent supplement to animal feed, both palatable and nutritious. Mushrooms, however, are the fruit of an organism (the fungus) and the bulk of the fungal organism is a mycelial mat. Fungus added to an appropriate substrate will quickly form a mycelial mat which may eventually produce the fruit mushrooms. All of the mycelial mat, however, would be appropriate animal feed. Worms and other invertebrates could be sustained on dried sludge or sludge compost and these too could be incorporated as animal feed. Algae and other aquatic organisms that are seen as a problem caused by waste disposal in waterways (blooms/eutrophication) could be specifically grown and harvested for food value.

Microorganisms could be found or engineered to produced chemicals that improved the odor. Microorganisms could be found or engineered to produced chemicals that improved the flavor or palatability of the sludge to increase its value as a feed supplement. The sterile output could be inoculated with microorganisms that enhanced the productivity for methane, and these would not need to compete with all of the normal fecal organisms that were in the original sewage.

Nutritional value of any food is dependent on the ability to digest that material. The chemical composition of sewage is almost exactly the same as the chemical composition of food (proteins, carbohydrates, and fats, mixed with some indigestible carbohydrates like cellulose/fiber). The caloric value of dry animal waste depending on source and method of measurement ranges between 12 and 17 MJ/Kg or 3000-4000 Calories per kilogram. This is roughly the equivalent energy content of dry firewood (somewhat less energy per Kg than coal and about half that of liquid fossil fuels). These values reflect waste being burned his fuel. When compared to other animal feeds, this has the same caloric density as corn or other cereal grains. How much of that energy is available as food depends on the ability of the animal to absorb the organic components. Common processes that increased the recovery of nutritional value include grinding, cooking, and chemical pretreatment. Humans cook their food to recover more nutritional value, and ruminant animals reprocess their food with the addition of acidity and bacteria and repeated chewing in order to increase the fraction of absorbable nutrient (chewing cud). The present invention is a form of “cooking” the material as well as potentially grinding the material. The fecal material has already been pre-digested by the animal producing that material and the gut bacteria of that animal. Therefore, animal waste once treated by heat sterilization would have a very high food value that was more easily digested/absorbed by the animal than the original plant based food. The value of this as food, though, would depend on its palatability. The output does not have a fecal odor but still has an odor. Which animals would be willing to accept this as a component of their feed and as how large a fraction would require practical testing and likely the addition of other food elements that are more palatable. The animals receiving this kind of pre-digested feed would produce less fecal waste and less methane than if they had been fed standard plant based food. This would clearly be the output products with the highest economic value.

### Application #1

Consider a feed lot/dairy farm. This will be paved to allow collection of all the animal waste without mixing in soil and without contaminating groundwater.

Waste is pushed or washed into a drainage system.

The waste is channeled into a settling tank to divide effluent from solids. The solids can enter an anaerobic digester that produces methane. The untreated effluent can be used to wash animal waste into the system.

The liquid component leaving the settling tank flows into a sterilization loop producing sterile broth which is then added directly to animal feed.

Solid product (after anaerobic digestion for methane) is ground to reduce component size and then flows through a separate sterilization loop.

Solid output is a sterile slurry which also can be added directly to animal feed (limited by palatability).
The cost of animal feed is significantly reduced since there is significant caloric/nutrient value added both by liquid and solid components of waste recycling.
Excess treated solids become fertilizer/compost.
Excess treated liquids become irrigation.
Fungus and worms grown on the sterilized solid waste are also added to the animal feed.
Animal feed that has been predigested and cooked will contain less non-digestible material. This reduction in non-digestible material would reduce the amount of methane and solid waste produced by the animal consuming that feed.
Fuel for the sterilization process (heat and electricity) is from methane derived from the animal waste making the whole process potentially carbon neutral.
Biological waste from dairy processing or meat processing could enter the same recycling stream.
This hypothetical feed lot produces no biological waste or runoff. This potentially requires no fuel, requires less feed, and produces less CO₂ for a comparable amount of product.
There is no sewage lagoon. There is no runoff. There is no groundwater contamination. The facility smells better.
In a closed system such as this there is no concern for heavy metals or other toxins.
Similar close systems could be achieved with human waste such as a cruise ship or the sewage system for a residential community where there was no industrial contamination of the sewage system and restrictions on chemical disposables in the homes. Here the system outputs would of course not be returned to human food.
This example is also the optimal test site for this heat treatment technology.

### Application #2

Consider a source of human or animal waste in a low resource setting.

Like any system the garbage and the grit would need to be removed. The effluent and sludge could be separated or not. The material could be ground to reduce size or not. The effluent could be sterilized or not and then used for irrigation. The sludge would be sterilized.

Alternatively, the entire waste stream could be heat sterilized. This would include some kind of mixing or blending to keep the solid and liquid elements mixed and provide some flotation for the solid elements. The choice to not perform primary processing would be made to reduce cost and simplify the process. Settling tanks and skimmers are a large capital investment.

The sterile sludge output could be used in all of the ways described previously. If the sludge had a higher water content because it had not initially been separated it would still have the same value as irrigation and fertilizer. In a low resource setting the distance between processing and application of product is likely to be small so transportation costs would not be prohibitive. These costs are likely to be acceptable compared to the cost of buying chemical fertilizer.

Heat treatment as outlined herein would be most applicable to small systems where transport distance between waste source and output product destination is relatively small.

To summarize: the waste is ground or blended and then sterilized by heat and then applied directly to the soil or used for making compost. All of the biologic material is returned to agriculture but there is no infectious risk and less odor. Clean water that might be used for drinking is not committed to agriculture. Dirty water that came from sewage does not contaminate waterways or drinking water. The entire processing system is short and cheap. There is an energy cost for the heat sterilization; the present invention provides heat sterilization with the lowest possible energy cost.

All of this is low tech. The whole system consists of a pipe, a pump, a heater, and a grinder. Nothing high tech. No chemicals are added/needed. In low resource settings, soil conservation is often poor. Fields may be periodically burned. The cost of fertilizer may be prohibitive. Crops are usually grown without the option of significant irrigation. The need for food prevents fields from being left fallow to regenerate. Soil exhaustion and erosion are constant threats. Organic farming practices teach us that composting is essential to maintaining productivity. Using human waste treatment for food production may be essential in low resource settings. This may well be a safe option if the waste source has limited non-biodegradable toxic substances.

The current paradigm is to process the wastewater until it can go into public waterways. This incurs a large energy cost, it puts most of the carbon into the air as CO₂ and dumps the rest in a landfill, creating methane. But the high cost of this approach means that only a small part of the world’s sewage is processed at all. Most is just dumped or ignored. The alternative paradigm described herein is that waste is processed just until it can be used for a biological purpose as irrigation or fertilizer or compost or feedstock. This represents far less processing with far less energy consumption, far less cost and far less CO₂ production.

Carbon credits or carbon taxes are likely to be a part of governmental responses to climate change. Sooner or later sewage treatment will receive the same scrutiny as fossil fuels. Sewage treatment strategies that reduce carbon emissions and return carbon to soil will certainly have lower costs and may become an income source (carbon credits) compared to standard sewage treatment.

This would challenge current thinking. We would stop discharging wastewater into water ways. We would use partially treated wastewater for irrigation. We would transport sewage sludge in liquid form. There would be markets for sewage sludge creating industries for soil restitution and compost and fertilizer. We would work with partially treated sewage. Even though the treated sewage would be sterile, using it in new ways would violate longstanding cultural norms. Wastewater treatment would be integrated into other industries including solid waste management and non-food agriculture.

If the goal for sewage treatment in the age of global warming is that all carbon waste should be returned to a biological purpose rather than becoming carbon dioxide, then the invention presented here of efficient heat sterilization becomes an essential tool in moving towards the new paradigm.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims incorporated herein.

### DETAILED DESCRIPTION OF THE DRAWINGS

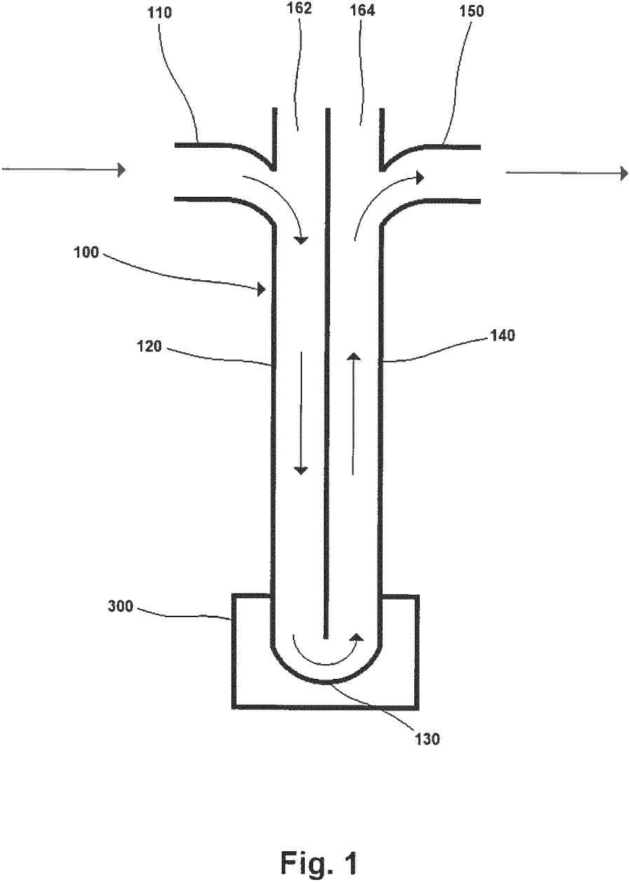

FIG. 1 is a schematic representation of a basic embodiment of the present invention. It depicts a single loop device, said loop having an inlet, a vertical down leg, a horizontal bottom, a vertical up leg, and an outlet, with arrows showing the direction of flow of a fluid contained within said loop.

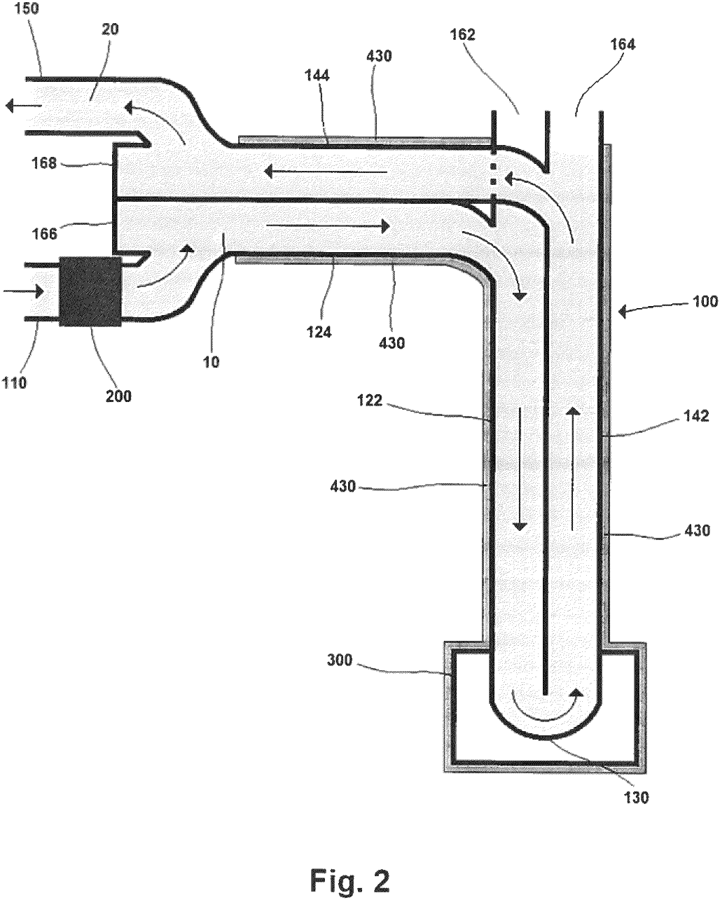

FIG. 2 is a schematic representation of an alternative embodiment of the present invention. It depicts a single loop device, said loop having an inlet, a horizontal down leg, a vertical down leg, a horizontal bottom, a vertical up leg, a horizontal up leg, and an outlet, with arrows showing the direction of flow of a fluid contained within said loop.

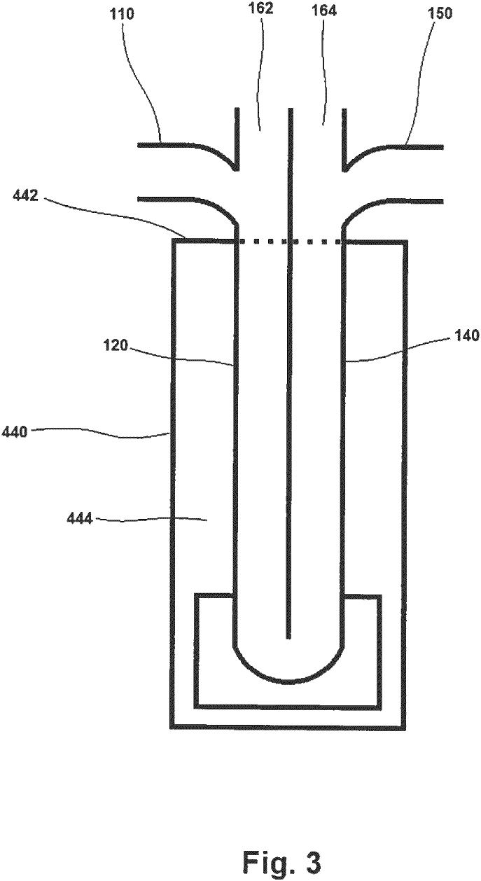

FIG. 3 is a schematic representation of yet another alternative embodiment of the present invention. It depicts a single loop device as shown in FIG. 1, with said loop being placed within a vacuum chamber.

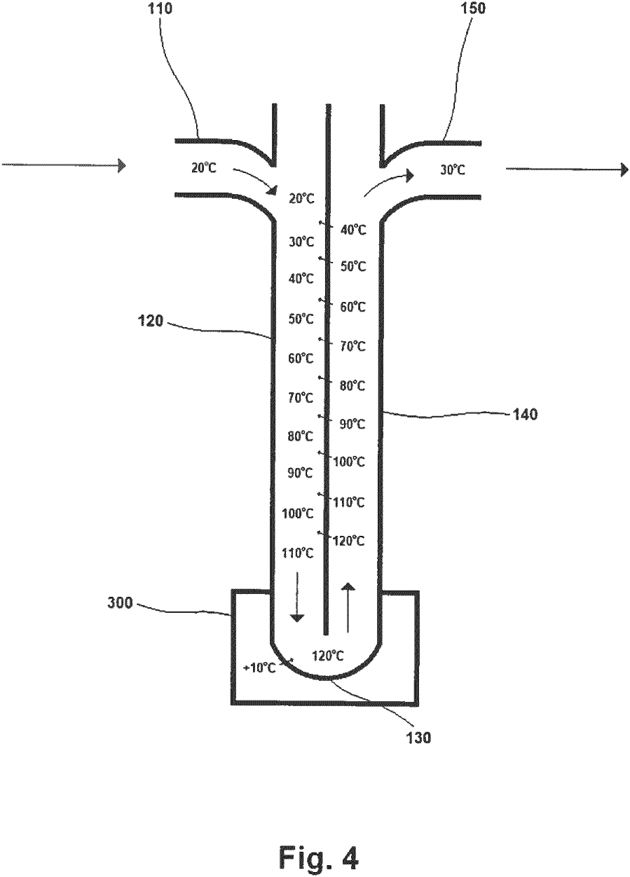

FIG. 4 is a schematic representation of the basic embodiment of the present invention shown in FIG. 1, depicting changes in temperature of the fluid moving through the loop, assuming a 10° C. temperature gradient between the down leg and the up leg of the loop and a 10° C. heat addition at the bottom of the loop.

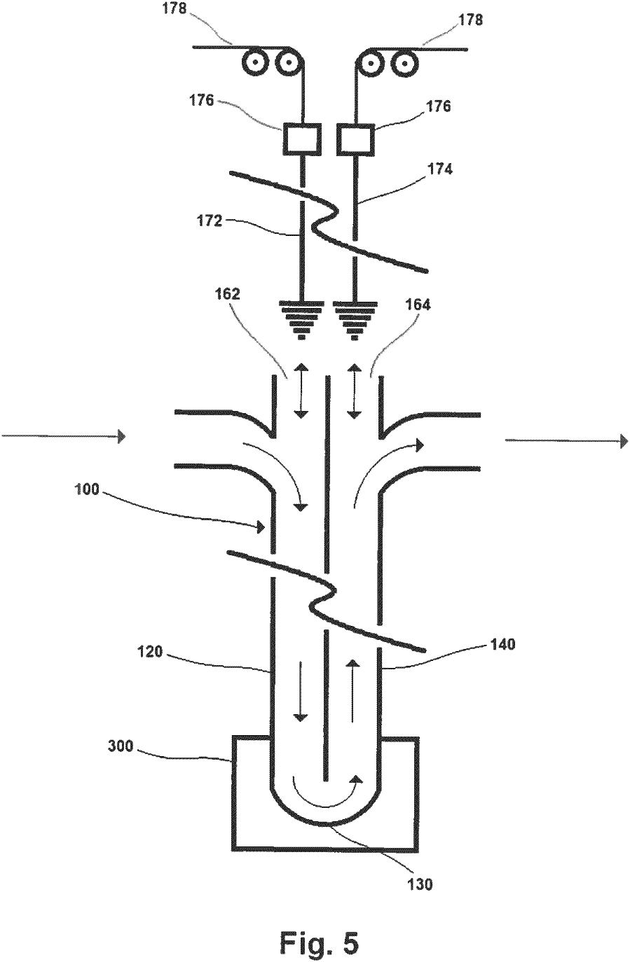

FIG. 5 is a schematic representation of yet another alternative embodiment of the present invention, depicting one means for cleaning the device using clean out brushes and motorized hoists to lower the brushes into the legs of the loop. Vertical portions of the device are truncated.

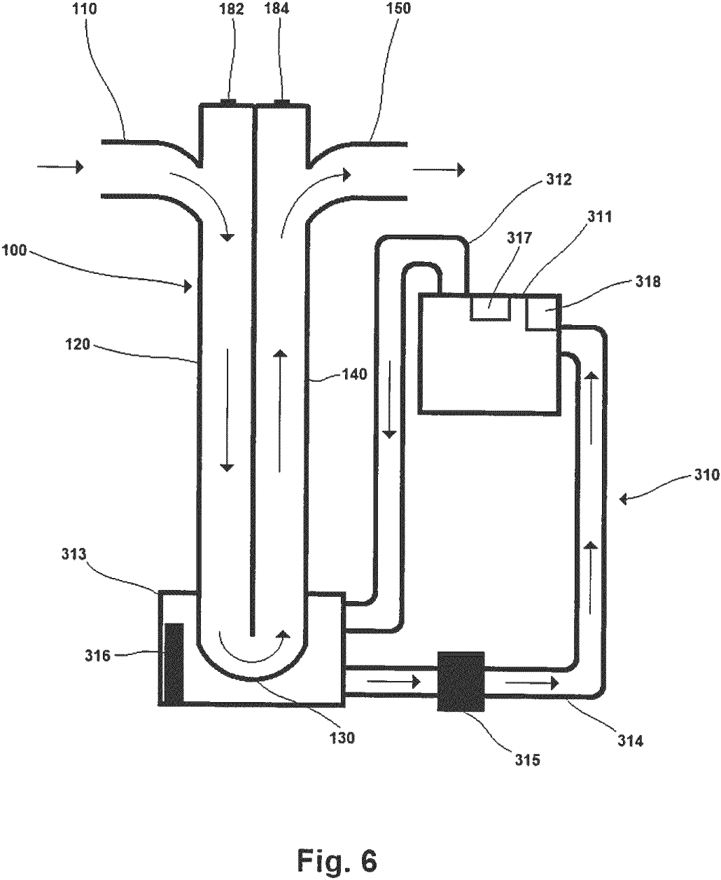

FIG. 6 is a schematic representation of yet another alternative embodiment of the present invention, depicting one means for providing heat to the bottom of the loop, namely, a closed steam heat loop system, with arrows showing the direction of movement of steam and water within the system.

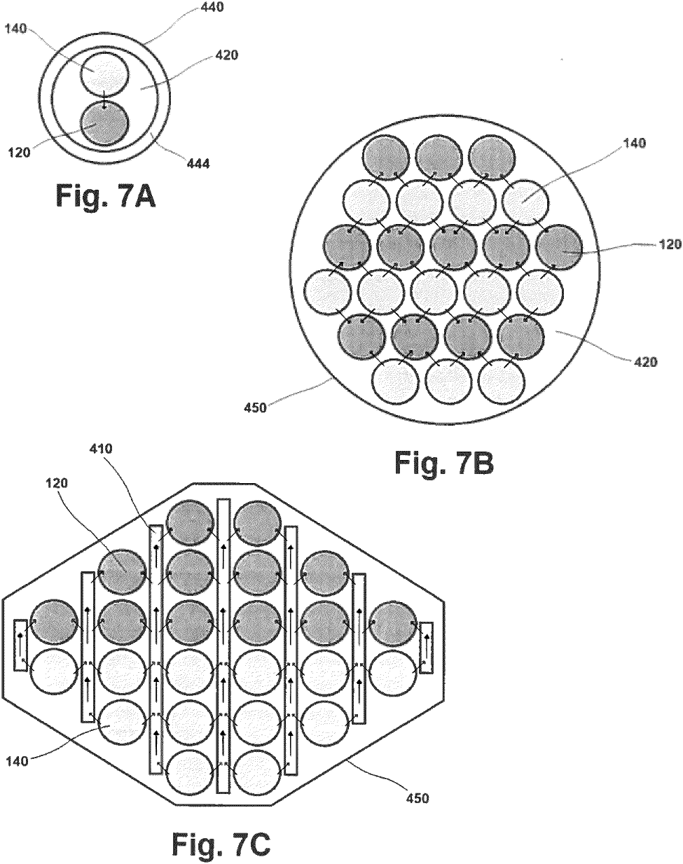

FIG. 7A is a top view cross-sectional schematic representation of yet another alternative embodiment of the present invention having a single loop, whereby the down leg and up leg of the loop are placed within a vacuum chamber and a heat conducting medium surrounds the down leg and the up leg, facilitating heat transfer therebetween. The arrow shows the direction of heat energy movement from the up leg to the down leg through the heat conducting medium.

FIG. 7B is a top view cross-sectional schematic representation of yet another alternative embodiment of the present invention having multiple loops, whereby the loops are placed in close proximity to each other such that every down leg is adjacent to at least two up legs, and further with a heat conducting medium surrounding the loops, facilitating heat transfer therebetween. Arrows show the direction of heat energy movement from the up legs to the down legs through the heat conducting medium.

FIG. 7C is a top view cross-sectional schematic representation of yet another alternative embodiment of the present invention having multiple loops, whereby the loops are placed in close proximity to each other with heat exchanging conduits placed therebetween. Arrows show the direction of heat energy movement from the up legs to the down legs through the heat exchanging conduits.

### DETAILED DESCRIPTION OF THE INVENTION

The present invention is a device for sterilizing fluid waste to render said waste noninfectious. The device comprises a conduit means, a pump 200. and a heating means 300. The conduit means is configured for containing fluid waste. The pump 200 is configured for moving fluid waste through the conduit means at a controlled flow rate. The heating means 300 is configured to apply heat energy to at least a portion of the fluid waste contained within the conduit means.

The conduit means comprises at least one loop 100. The loop 100 is at least partially oriented substantially vertically and has an inlet 110, a down leg 120, a transverse bottom 130, an up leg 140, and an outlet 150. At least a portion of the down leg 120 of the loop 100 is oriented substantially vertically. At least a portion of the up leg 140 of the loop 100 is oriented substantially vertically and is located proximate to the vertically oriented portion 122 of the down leg 120 of the loop 100. The portions of the down leg 120 and the up leg 140 that are located proximate to each other serve as a heat exchanger; that is, heat energy in the fluid contained in one leg is transferred through the walls of the legs into the fluid contained in the other leg. When the system is operating, the up leg 140 contains fluid having a higher temperature than the fluid contained in the down leg 120. so that the heat energy transfer is from the fluid in the up leg 140 to the fluid in the down leg 120. Various alternate embodiments of the system, described below, improve upon the heat exchange function described herein.

The transverse bottom 130 of the loop 100 is in communication with a lower portion of the down leg 120 of the loop 100 and in communication with a lower portion of the up leg 140 of the loop 100. thereby providing fluid communication from the down leg 120 of the loop 100 to the up leg 140 of the loop 100. The down leg 120 of the loop 100. the bottom 130 of the loop 100. and the up leg 140 of the loop 100 form a U-shape. The inlet 110 of the loop 100 provides access to the upper portion of the down leg 120 of the loop 100 such that unsterilized fluid waste 10 can enter the down leg 120 of the loop 100 via the inlet 110. The outlet 150 of the loop 100 provides access from the upper portion of the up leg 140 of the loop 100 such that sterilized fluid waste 20 can exit the up leg 140 of the loop 100 via the outlet 150. See FIG. 1. The loop 100 may be made of any suitable material, provided it is rigid and durable. However, materials that are heat conductive are preferred, such as non-corrosive metallic materials.

The pump 200 may be any suitable inline pumping device that is configured to move fluid through a conduit. Preferably, the pump 200 is located at a portion of the down leg 120 of the loop 100, distal from the bottom 130 of the loop 100. Multiple pumps 200 may be used, if needed. The pump 200 should be able to move fluid at a variable flow rate, so that the volume of waste fluid will be exposed to a known quantity of heat energy for a known period of time, thereby achieving sterilization (a lesser amount of heat energy will require longer exposure, and therefore a slower flow rate, while a higher amount of heat energy will require shorter exposure, and therefore a faster flow rate).

The heating means 300 is located proximate to the bottom 130 of the loop 100 and is configured to apply heat to fluid waste located in the bottom 130 of the loop 100. It may encompass any suitable device or mechanism suitable for applying heat energy to the fluid. In one embodiment, the heating means 300 is a closed loop steam system 310. The steam system 310 comprises a boiler 311, a steam pipe 312, a condenser 313, a water return pipe 314, and a pump 315. Water is heated within the boiler 311 to form steam, the steam flows through the steam pipe 312 to the condenser 313. which surrounds the bottom 130 of the loop 100 of the conduit means, heat energy is given off from the steam to the fluid waste contained within the bottom 130 of the loop 100, thereby heating the fluid and returning the steam to water, and the water is pumped from the condenser 313 through the water return pipe 314 to the boiler 311. The closed loop steam system 310 may further comprise a water level sensor 316. a pressure gauge 317, and a controller 318, wherein the water level sensor 316 measures the level of the water in the condenser 313 and the pressure gauge 317 measures the pressure of the steam in the boiler 311. The water level sensor 316 and the pressure gauge 317 provide inputs to the controller 318, which controls the amount of heat applied to the water in the boiler 311 and controls the pump circulation speed based on those inputs. This provides a desired amount of heat energy at the bottom 130 of the loop 100 of the conduit means.

In one embodiment of the present invention, the conduit means contains a plurality of loops 100. Each of the loops 100 has associated with it at least one pump 200 configured to move fluid waste through it. The heating means is configured to apply heat to fluid waste located in the bottom 130 of each of the loops 100. When multiple loops 100 are used, they each should be placed in close proximity to the other loops 100. This allows heat energy from sterilized fluid 20 flowing through the up legs 140 of the loops 100 to be transferred to unsterilized fluid 10 flowing through the down legs 120 of multiple loops 100, increasing the efficiency of the heat exchange.

The conduit means may further comprise one or more heat exchanging conduits 410. Each heat exchanging conduit 410 is configured to facilitate the transfer of heat energy from fluid waste 20 contained within the up leg 140 of the loop 100 to fluid waste 10 contained within the down leg 120 of the loop 100. Heat exchanging conduits 410, such as heat pipes, are well known in the art. The heat exchanging conduit 410 may be a solid member that is heat conductive; or, it may be hollow, and filled with a heat conducting liquid or gas. Where a heat conducting liquid is used, this liquid is kept separate from and never mixes with the fluid 10.20 contained within the loop 100. In all configurations, the heat exchanging conduit 410 is preferred to be oriented such that it is angled upwards from the up leg 140 of the loop 100 to the down leg 120 of the loop 100. An alternative to the use of heat exchanging conduits 410 is to encase or surround at least a portion of the loop 100 of the conduit means within a heat conducting medium 420. The heat conducting medium 420 may be a heat conducting metal or a heat conducting fluid.

In another embodiment, at least a portion of the down leg 120 of the loop 100 is oriented substantially horizontally, and at least a portion of the up leg 140 of the loop 100 is oriented substantially horizontally. The horizontal portion of the up leg 140 of the loop 100 is located proximate to the horizontal portion of the down leg 120 of the loop 100. The horizontal portions 124,144 of the legs 120, 140 are located distal from the bottom 130 of the loop 100, such that the vertical portions 122, 142 of the legs 120, 140 are located between the horizontal portions 124, 144 of the legs 120, 140 and the bottom 130 of the loop 100. See FIG. 2.

The loop 100 of the conduit means should have a first cleanout access point 162 and a second cleanout access point 164. The first cleanout access point 162 is located on the down leg 120 of the loop 100 proximate to the upper portion of the down leg 120 of the loop 100. The second cleanout access point 164 is located on the up leg 140 of the loop 100 proximate to the upper portion of the up leg 140 of the loop 100. Each cleanout access point 162, 164 provides access into its respective leg of the loop 100 for the insertion of a cleanout mechanism into that leg of the loop 100. The down leg cleanout mechanism 172 should be kept separate from the up leg cleanout mechanism 174 to prevent contamination of the sterilized fluid 20 contained within the up leg 140 of the loop 100. In the preferred embodiment the down leg cleanout mechanism 172 is a brush, and the up leg cleanout mechanism 174 is a brush. In the most preferred embodiment a motor 176 drives each of the brushes 172, 171. A hoist 178 may be used to position the brushes 172, 174 over the cleanout access points 162, 164. In the embodiment of the invention where the down leg 120 and the up leg 140 each comprise a horizontal portion, the loop 100 further contains a third cleanout access point 166 and a fourth cleanout access point 168. The third cleanout access point 166 is located on the horizontal portion of the down leg 120 of the loop 100 at a point distal from the vertical portion 122 of the down leg 120 of the loop 100, and the fourth cleanout access point 168 is located on the horizontal portion of the up leg 140 of the loop 100 at a point distal from the vertical portion 142 of the up leg 140 of the loop 100. See FIG. 2.

In each of the foregoing embodiments, each cleanout access point may have a removable cleanout access point cover. The first cleanout access point cover 182 is removed from the first cleanout access point 162 of the loop 100 to provide access into the down leg 120 of the loop 100, and is placed onto the first cleanout access point 162 of the loop 100 to seal off access into the down leg 120 of the loop 100 through the first cleanout access point 162 of the loop 100. The second cleanout access point cover 184 is removed from the second cleanout access point 164 of the loop 100 to provide access into the up leg 140 of the loop 100, and is placed onto the second cleanout access point 164 of the loop 100 to seal off access into the up leg 140 of the loop 100 through the second cleanout access point 164 of the loop 100. Where applicable, the third cleanout access point cover is removed from the third cleanout access point 166 of the loop 100 to provide access into the substantially horizontally oriented portion 124 of the down leg 120 of the loop 100. and is placed onto the third cleanout access point 166 of the loop 100 to seal off access into the substantially horizontally oriented portion 124 of the down leg 120 of the loop 100 through the third cleanout access point 166 of the loop 100, and the fourth cleanout access point cover is removed from the fourth cleanout access point 168 of the loop 100 to provide access into the substantially horizontally oriented portion 144 of the up leg 140 of the loop 100. and is placed onto the fourth cleanout access point 168 of the loop 100 to seal off access into the substantially horizontally oriented portion 144 of the up leg 140 of the loop 100 through the fourth cleanout access point 168 of the loop 100. The cleanout access point covers thereby prevent fluid waste, and associated odors, from escaping from the loop 100 during operation of the system.

In one embodiment, at least a portion of the conduit means is wrapped in an insulating material 430. This minimizes heat loss and allows for more heat energy to be available to be transferred between the fluid 20 contained in the up leg 140 of the loop 100 and the fluid 10 contained in the down leg 120 of the loop 100. Alternatively, at least a portion of the conduit means may be enclosed within a vacuum chamber 440. The evacuated space 444 between the conduit means and the vacuum chamber 440 minimizes heat loss. The exterior of the vacuum chamber 440 may also be insulated.

To achieve the desired pressures that allow the waste fluid to be heated to higher temperatures, the down leg 120 and the up leg 140 of the loop 100 should have a height of at least 20 meters, and preferably 30 meters. Greater heights are also contemplated, allowing for greater pressures. In the embodiment of the invention comprising legs 120, 140 with horizontal portions 124, 144 as well as vertical portions 122, 142, these height requirements pertain to the vertical portions 122, 142 of the legs 120, 140.

Turning to the basic embodiment of the device shown in FIG. 1, fluid 10 enters the inlet 110 of the down leg 120 of the loop 100 at 1 atmosphere of pressure: that is, it is unpressurized. As the fluid travels through the down leg 120, the amount of fluid above it in the down leg 120 increases the pressure. Each 10 meters of depth of the down leg 120 adds approximately another atmosphere of pressure to the fluid. At a depth of 30 meters, the fluid at the bottom 130 of the loop 100 is increased by about 3 atm. At that pressure, the boiling point of water (about of 144° C.) is significantly higher than the temperature needed for sterilization purposes. As the fluid passes through the bottom 130 of the loop 100 and then though the up leg 140 of the loop 100, the pressure decreases, until upon the fluid 20 exiting the outlet 150 of the up leg 140 it is back to 1 atmosphere of pressure.

Because the device of the present invention is designed to allow heat transfer between the up leg 140 of the loop 100 and the down leg 120 of the loop 100, fluid 10 moving through the down leg 120 of the loop 100 passively absorbs heat energy contained in fluid 20 moving through the up leg 140 of the loop 100. FIG. 4 provides an idealized example of the heat transfer capabilities of this system. As shown in FIG. 4, assume fluid enters the inlet 110 to the down leg 120 at 20° C. Further assume a depth of the up and down legs 120, 140 of the loop 100 of 30 meters (roughly 100 feet), a 10° C. heat gradient (meaning, at any given depth, the fluid in the up leg 140 is 10° C. warmer than the fluid in the down leg 120), and a heat energy transfer of about 1° C. for every foot of travel; then, for every ten feet of travel (roughly 3 meters) approximately 10° C. of heat energy is transferred from the up leg 140 to the down leg 120 of the loop 100. As shown in FIG. 4, fluid near the top of the down leg 120, having a temperature of 20° C., will absorb heat energy from the fluid near the top of the up leg 140, having a temperature of about 40° C., and over the course of about 3 meters of travel will receive 10° C. of heat energy from the fluid in the up leg 140, raising the temperature of the fluid in the down leg 120 to 30° C., and resulting in the temperature of the fluid in the up leg 140 dropping to 30° C. As the fluid continues to move through the down leg 120, the 30° C. fluid in the down leg 120 receives 10° C. of heat energy from the 50° C. fluid in the up leg 140 over the next 3 meters of travel, thereby raising the down leg 120 fluid to 40° C. further movement of the fluid through the down leg 120 results in the 40° C. fluid in the down leg 120 receiving 10° C. of heat energy from the 60° C. fluid in the up leg 140 over the next 3 meters of travel, thereby raising the down leg 120 fluid to 50° C. This continues all the way to the bottom of the down leg 120. where the fluid temperature is ultimately raised to 110° C. by the passive transfer of heat energy from the fluid in the adjacent portion of the up leg 140. Within the bottom 130 of the loop 100, 10° C. of additional heat energy is added to the fluid by the external heat source, raising it to the desired sterilizing temperature of 120° C. When the fluid 20 finally exits the outlet 150 of the up leg 140 of the loop 100, it will have a temperature of about 30° C. representing a 10° C. increase in temperature over the temperature of the fluid 10 entering the down leg 120 of the loop 100, which is the amount of energy added by the external heat source at the bottom 130 of the loop 100.

It is noted that the system has to be “charged” before the above described process can begin. That is, before any additional external heat energy is added at the bottom 130 of the loop 100, the entirety of fluid in the loop 100 will be at the same temperature. Adding heat energy to the bottom 130 of the loop 100 will start the process as described above, but only for the fluid in the down and up legs 120, 140 nearest the bottom 130 of the loop 100. As more external heat energy is added, the fluid at ever further distances from the bottom 130 of the loop 100 will have increased temperatures, until eventually all of the fluid within the loop 100 achieves the temperature profile as shown in FIG. 4 and described in the above example.

In actual practice, heat energy is not transferred in discrete blocks, but rather on a continuum, so that at no time will the temperature of the fluid 10 in the down leg 120 of the loop 100 rise all at once, as suggested by the above example, but rather it will rise by small amounts continuously so that after a given distance of travel the temperature will have been raised. The same is true for the decrease in temperature of the fluid 20 in the up leg 140 of the loop 100. Moreover. FIG. 4 depicts an idealized version of the passive/active heating means, and in practice there will be some inefficiency of heat transfer and/or loss of heat energy, so that the final temperature of fluid reaching the bottom 130 of the loop 100 may be lower than the idealized temperature given in the example, necessitating a somewhat higher amount of active heat energy to be added. Nevertheless, the device is able to raise the temperature of the fluid a significant amount (in this example, 100° C.) with a relatively small amount of added external heat energy (10° C.). Even with inefficiencies, the ratio of temperature increase to added external heat energy is substantial, with a very large gain of temperature for sterilization purposes being achieved with a relatively small amount of additional external heat.

The embodiment of the present invention shown in FIG. 2 depicts an alternate version whereby, in addition to the vertical down leg 122 and vertical up leg 142, the loop 100 also includes a horizontal down leg portion 124 and a horizontal up leg portion 144. The horizontal portions 124, 144 of the legs 120, 140 contain unpressurized fluid. By arranging the horizontal portions 124, 144 of the legs 120, 140 adjacent to each other, heat transfer from the fluid contained in the up leg portion 140 of the loop 100 to the fluid contained in the down leg portion 120 of the loop 100 occurs in the same manner as described above with regard to the vertical portions 122, 142 of the legs 120, 140. Therefore, heat exchange occurs over a much longer distance, thereby increasing the efficiency of the overall heat transfer. As such, the flow rate of the fluid can be increased, permitting faster sterilization of a given amount of fluid as compared with the basic configuration shown in FIG. 1. Taking the example provided above, wherein heat transferred at a rate of 1° C. per linear foot, doubling the fluid flow rate would decrease the heat transfer rate by half, to 0.5° C. per linear foot, but if the horizontal portions 124, 144 of the legs 120, 140 result in a doubling of the overall length of the loop 100. the end result would be the same increase in the temperature of the fluid in the down leg 120 of the loop 100 when it reaches the bottom 130 of the loop 100. Another advantage of this configuration is the lower cost of construction and installation of the horizontal portions 124, 144 of the loop 100 compared with the vertical portions 122, 142. Therefore, to the extent that some of the raising of temperature in the down leg 120 can be achieved within a horizontal portion of the down leg 120, the overall cost of the system can be lowered.

FIG. 7A shows an embodiment of the present invention that uses a single loop 100. The down leg 120 and up leg 140 of the loop 100 are contained within a heat conducting medium 420. This medium 420 may be a heat conducting metal, or a heat conducting fluid, or a heat conducting gas. In preferred embodiments the heat conducting medium 420 is a heat conducting metal, such as aluminum. The down leg 120 and the up leg 140 of the loop 100 and the heat conducting medium 420 are then contained within a vacuum chamber 440 to minimize heat loss.

FIGS. 7B and 7C show alternate embodiments of the present invention that use multiple loops 100 running in parallel to each other and contained within a single retaining chamber 450. In FIG. 7B, the down legs 120 and up legs 140 of each loop 100 are contained within a heat conducting medium, as described above. Moreover, the loops 100 are arranged so that each down leg 120 is within close proximity of at least two up legs 140. with some down legs 120 being in close proximity to three or more up legs 140. This increases the efficiency of heat transfer between fluid 20 contained in the up legs 140 of the loops 100 and fluid 10 contained within the down legs 120 of the loops 100. In FIG. 7C. heat exchanging conduits 410 are placed between the down legs 120 and up legs 140 of the loops 100. Fluid or gas within the heat exchanging conduits 410 receive heat energy from the fluid 20 contained within the up legs 140 and transfers it to fluid 10 contained in the down legs 120. Preferably, each heat exchanging conduit 410 is sloped upward from an up leg 140 to a down leg 120. In order to configure the loops 100 such that all of the down legs 120 are located proximate to each other on one side, and all of the up legs 140 are located proximate to each other on the other side, the bottoms 130 of the loops 100 are at different depths, allowing loops 100 to be nested within each other. Thus, the loops 100 arranged in a vertical column in FIG. 7C can be viewed as a series of nested loops 100, with the inner most loop 100 having its down leg 120 and up leg 140 proximate to each other, and any outer loop 100 having its down leg 120 separated from its up leg 140 by the down leg 120 and up leg 140 of one or more nested loops 100.

The arrangements shown in FIGS. 7B and 7C lend themselves to alternative designs whereby each of the loops 100 share a common bottom portion 130 with all of the other loops 100. This allows for a more uniform final temperature of the fluid at the bottom 130 of the loops 100. This may be necessary because fluid in the down legs 120 receiving heat energy from only two proximal up legs 140 may arrive at the bottom 130 of the loop 100 at a lower temperature than fluid in the down legs 120 receiving heat energy from three or more proximal up legs 140. By entering into a common bottom portion 130, the fluid from all of the down legs 120 mixes and achieves a more uniform temperature.

The embodiment of the present invention shown in FIG. 3 depicts an alternate version whereby the down leg 120 and the up leg 140 of the loop 100 are contained within a vacuum chamber 440. See also FIG. 7A. As shown in FIG. 3, the sole point of contact between the loop 100 and the vacuum chamber 440 is at the top 442 of the vacuum chamber 440 located proximate to the tops of the down leg 120 and up leg 140 of the loop 100, where the temperature of the fluid is lowest. This minimizes heat loss from the point of contact.

FIG. 5 shows one embodiment of a cleanout mechanism. Because of the vertical orientation of the down leg 120 and the up leg 140, clean out access points 162, 164 at the top of each leg 120, 140 allow the legs 120, 140 to be cleaned even while the system is operating. Using different cleanout brushes 172, 174, one for the down leg portion 120 (containing nonsterile fluid 10) and one for the up leg portion 140 (containing sterilized fluid 20), prevents cross contamination. The cleanout brushes 172, 174 are suspended from motorized hoists 178 and inserted into the respective legs 120, 140 of the loop 100, and are moved along length of the leg, scraping the inner surfaces of the leg from top to bottom and dislodging any residue that had accumulated thereon. The resulting debris scraped from the inner surfaces flows through and out of the system during operation. In embodiments where horizontal portions 124, 144 of the legs 120, 140 of the loops 100 are used, see FIG. 2, cleaning the horizontal portions 124, 144 of the legs 120, 140 can be achieved using the same types of cleanout brushes, but operation of the system would have to be halted so that fluid contained in the horizontal portions 124, 144 of the loop 100 does not spill out when the cleanout access ports 166, 168 are opened. Debris scraped from the inner surfaces of the horizontal portions of the loop 100 flows through and out of the system when operation is resumed.

FIG. 6 shows an embodiment of the present invention that uses a closed loop steam system 310 for providing external heat energy to the device. A boiler 311 heats water until it turns into steam. The wet steam flows out of the boiler 311 and through a steam pipe 312 down to the bottom 130 of the loop 100, where the steam enters a condenser 313 containing the bottom 130 of the loop 100. The steam gives off heat energy to the fluid contained in the bottom 130 of the loop 100 and condenses back to water. The water is then pumped up a water return pipe 314 back to the boiler 311. The steam pipe 312 may be insulated, or contained within a vacuum chamber, to minimize heat loss. A water level sensor 316 in the condenser 313 and a pressure gauge 317 at the boiler 311 provide inputs to a controller 318. The controller 318 controls the heat applied to the water in the boiler 311 and the speed of the pump 315 circulating the water return, thereby providing the desired amount of heat energy at the bottom 130 of the loop 100. Alternate heating means 300 for providing heat energy to the bottom 130 of the loop 100 are also contemplated, such as geothermal heating, electric resistance heating, and other known heating methods.

The present invention also discloses a method for sterilizing fluid waste to render said waste noninfectious. The method comprising the following steps:
Step A: obtain the device described above;
Step B: pump fluid waste into and through the conduit means, wherein unsterilized fluid waste 10 enters the down leg 120 of the loop 100 of the conduit means through the inlet 110 of the loop 100 and sterilized fluid waste 20 exits the up leg 140 of the loop 100 of the conduit means through the outlet 150 of the loop 100;
Step C: apply heat energy by use of the heating means to the fluid waste that is located within the bottom 130 of the loop 100 of the conduit means; and
Step D: apply heat energy from the fluid waste that is located in the up leg 140 of the loop 100 of the conduit means to the fluid waste that is located in the down leg 120 of the loop 100 of the conduit means, whereby said application of heat energy occurs passively.
Step A is performed before Steps B. C. and D. and Steps B. C. and D are performed simultaneously.

The method may further comprise the step of monitoring the flow and temperature of the fluid waste, and adjusting same as needed to provide sufficient heat to the fluid waste for a sufficient period of time to accomplish the desired sterilization of the fluid waste. This step occurs after Step A, and simultaneously with Steps B, C, and D.

While the preferred embodiments of the present invention have been described, modifications can be made and other embodiments may be devised without departing from the spirit of the invention.

I claim:

1. A device for sterilizing fluid waste to render said waste noninfectious, said device comprising
a conduit means, a pump, and a heating means, wherein
the conduit means is configured for containing and moving fluid waste therethrough at a controlled flow rate.
with said conduit means comprising a loop, said loop being at least partially oriented substantially vertically and having an inlet, a down leg, a bottom, an up leg, and an outlet,
wherein at least a portion of the down leg of the loop is oriented substantially vertically,
at least a portion of the up leg of the loop is oriented substantially vertically and is located proximate to said vertically oriented portion of the down leg of the loop,
the bottom of the loop is in communication with a lower portion of the down leg of the loop and in communication with a lower portion of the up leg of the loop, thereby providing fluid communication from the down leg of the loop to the up leg of the loop, whereby the down leg of the loop, the bottom of the loop, and the up leg of the loop form a U-shape,
the inlet of the loop provides access to an upper portion of the down leg of the loop such that fluid waste enters the down leg of the loop via the inlet, and
the outlet of the loop provides access from an upper portion of the up leg of the loop such that fluid waste exits the up leg of the loop via the outlet;
the pump is configured to move fluid waste through the conduit means: and
the heating means is configured to apply heat to fluid waste located in the bottom of the loop.

2. The device of claim 1 wherein
the conduit means contains a plurality of loops,
wherein each of the loops has associated with it a pump configured to move fluid waste therethrough, and
the heating means is configured to apply heat to fluid waste located in the bottom of each of the loops.

3. The device of claim 1 wherein
the conduit means further comprises one or more heat exchanging conduits, with each heat exchanging conduit configured to facilitate the transfer of heat energy from fluid waste contained within the up leg of the loop to fluid waste contained within the down leg of the loop.

4. The device of claim 2 wherein
the conduit means further comprises a plurality of heat exchanging conduits, with each heat exchanging conduit configured to facilitate the transfer of heat energy from fluid waste contained within the up leg of one of the plurality of loops to fluid waste contained within the down leg of one of the plurality of loops.

5. The device of claim 1 wherein
at least a portion of the down leg of the loop is oriented substantially horizontally, and
at least a portion of the up leg of the loop is oriented substantially horizontally and is located proximate to said horizontally oriented portion of the down leg of the loop,
whereby the substantially horizontally oriented portion of the down leg of the loop is located between the inlet of the loop and the substantially vertically oriented portion of the down leg of the loop, and
the substantially horizontally oriented portion of the up leg of the loop is located between the outlet of the loop and the substantially vertically oriented portion of the up leg of the loop.

6. The device of claim 1 wherein
the loop of the conduit means has a first cleanout access point and a second cleanout access point,
wherein the first cleanout access point is located on the down leg of the loop proximate to the upper portion of the down leg of the loop, and
the second cleanout access point is located on the up leg of the loop proximate to the upper portion of the up leg of the loop,
whereby the first cleanout access point provides access into the down leg of the loop for the insertion of a down leg cleanout mechanism into the down leg of the loop, and
the second cleanout access point provides access into the up leg of the loop for the insertion of an up leg cleanout mechanism into the up leg of the loop.

7. The device of claim 6 wherein
the down leg cleanout mechanism is a brush, and
the up leg cleanout mechanism is a brush.

8. The device of claim 6 wherein
the down leg cleanout mechanism is a motorized brush, and
the up leg cleanout mechanism is a motorized brush.

9. The device of claim 6 wherein
the loop of the conduit means has a removable first cleanout access point cover and a removable second cleanout access point cover,
wherein the first cleanout access point cover is removed from the first cleanout access point of the loop to provide access into the down leg of the loop, and is placed onto the first cleanout access point of the loop to prevent access into the down leg of the loop through the first cleanout access point of the loop, and
the second cleanout access point cover is removed from the second cleanout access point of the loop to provide access into the up leg of the loop, and is placed onto the second cleanout access point of the loop to prevent access into the up leg of the loop through the second cleanout access point of the loop.

10. The device of claim 5 wherein
the loop of the conduit means has a first cleanout access point, a second cleanout access point, a third cleanout access point, and a fourth cleanout access point,
wherein the first cleanout access point is located on the down leg of the loop proximate to the location where the substantially vertically oriented portion of the down leg of the loop meets the substantially horizontally oriented portion of the down leg of the loop.
the second cleanout access point is located on the up leg of the loop proximate to the location where the substantially vertically oriented portion of the up leg of the loop meets the substantially horizontally oriented portion of the up leg of the loop,
the third cleanout access point is located on the down leg of the loop at a portion of the substantially horizontally oriented down leg of the loop located distal from the substantially vertically oriented portion of the down leg of the loop, and
the fourth cleanout access point is located on the up leg of the loop at a portion of the substantially horizontally oriented up leg of the loop distal from the substantially vertically oriented portion of the up leg of the loop,
whereby the first cleanout access point provides access into the substantially vertically oriented down leg of the loop for the insertion of a first down leg cleanout mechanism into the substantially vertically oriented down leg of the loop,
the second cleanout access point provides access into the substantially vertically oriented up leg of the loop for the insertion of a first up leg cleanout mechanism into the substantially vertically oriented up leg of the loop,
the third cleanout access point provides access into the substantially horizontally oriented down leg of the loop for the insertion of a second down leg cleanout mechanism into the substantially horizontally oriented down leg of the loop, and
the fourth cleanout access point provides access into the substantially horizontally oriented up leg of the loop for the insertion of a second up leg cleanout mechanism into the substantially horizontally oriented up leg of the loop.

11. The device of claim 10 wherein
the first down leg cleanout mechanism is a brush.
the second down leg cleanout mechanism is a brush,
the first up leg cleanout mechanism is a brush, and
the second up leg cleanout mechanism is a brush.

12. The device of claim 10 wherein
the first down leg cleanout mechanism is a motorized brush,
the second down leg cleanout mechanism is a motorized brush,
the first up leg cleanout mechanism is a motorized brush, and
the second up leg cleanout mechanism is a motorized brush.

13. The device of claim 10 wherein
the loop of the conduit means has a removable first cleanout access point cover, a removable second cleanout access point cover, a removable third cleanout access point cover, and a removable fourth cleanout access point cover,
wherein the first cleanout access point cover is removed from the first cleanout access point of the loop to provide access into the substantially vertically oriented down leg of the loop, and is placed onto the first cleanout access point of the loop to prevent access into the substantially vertically oriented down leg of the loop through the first cleanout access point of the loop,
the second cleanout access point cover is removed from the second cleanout access point of the loop to provide access into the substantially vertically oriented up leg of the loop, and is placed onto the second cleanout access point of the loop to prevent access into the substantially vertically oriented up leg of the loop through the second cleanout access point of the loop,
the third cleanout access point cover is removed from the third cleanout access point of the loop to provide access into the substantially horizontally oriented down leg of the loop, and is placed onto the third cleanout access point of the loop to prevent access into the substantially horizontally oriented down leg of the loop through the third cleanout access point of the loop, and
the fourth cleanout access point cover is removed from the fourth cleanout access point of the loop to provide access into the substantially horizontally oriented up leg of the loop, and is placed onto the fourth cleanout access point of the loop to prevent access into the substantially horizontally oriented up leg of the loop through the fourth cleanout access point of the loop.

14. The device of claim 1 wherein at least a portion of the conduit means is insulated.

15. The device of claim 1 wherein at least a portion of the conduit means is enclosed within a vacuum chamber.

16. The device of claim 1 wherein
the down leg of the loop has a height of between 20 to 30 meters, and
the up leg of the loop has a height substantially the same as the height of the down leg.

17. The device of claim 5 wherein
the substantially vertically oriented portion of the down leg of the loop has a height of between 20 to 30 meters, and
the substantially vertically oriented portion of up leg of the loop has a height substantially the same as the height of the substantially vertically oriented portion of the down leg of the loop.

18. The device of claim 1 wherein at least a portion of the loop of the conduit means is encased in a heat conducting metal.

19. The device of claim 1 wherein at least a portion of the loop of the conduit means is surrounded by a heat conducting fluid.

20. The device of claim 2 wherein at least a portion of each of the plurality of loops of the conduit means is encased in a heat conducting metal.

21. The device of claim 2 wherein at least a portion of each of the plurality of loops of the conduit means is surrounded by a heat conducting fluid.

22. The device of claim 1 wherein
the heating means is a closed loop steam system, said system comprising a boiler, a steam pipe, a condenser, a water return pipe, and a pump,
wherein water is heated within the boiler to form steam,
steam flows through the steam pipe to the condenser,
the condenser surrounds the bottom of the loop of the conduit means,
heat energy is given off from the steam to fluid waste contained within the bottom of the loop, thereby turning the steam to water, and
water is pumped from the condenser through the water return pipe to the boiler.

23. The device of claim 22 wherein
the closed loop steam system further comprises a water level sensor, a pressure gauge, and a controller,
wherein the water level sensor measures the level of the water in the condenser and the pressure gauge measures the pressure of the steam in the boiler, and
the water level sensor and the pressure gauge provide inputs to the controller, which controls heat applied to the boiler and controls the pump circulation speed based on said inputs, thereby providing a desired amount of heat energy at the bottom of the loop of the conduit means.

24. The device of claim 1 wherein the heating means is an electric heater.

25. The device of claim 1 wherein the heating means is a geothermal heater.

26. A method for sterilizing fluid waste to render said waste noninfectious, said method comprising the following steps:
Step A: obtain the device of claim 1;
Step B: pump fluid waste into and through the conduit means, wherein fluid waste enters the down leg of the loop of the conduit means through the inlet of the loop and fluid waste exits the up leg of the loop of the conduit means through the outlet of the loop;
Step C: apply heat energy by use of the heating means to fluid waste that is located within the bottom of the loop of the conduit means: and
Step D: apply heat energy from the fluid waste that is located in the up leg of the loop of the conduit means to the fluid waste that is located in the down leg of the loop of the conduit means, whereby said application of heat energy occurs passively;
wherein Step A is performed before Steps B, C, and D, and Steps B, C, and D are performed simultaneously.

27. The method of claim 26 wherein
the conduit means further comprises one or more heat exchanging conduits, with each heat exchanging conduit configured to facilitate the transfer of heat energy from fluid waste contained within the up leg of the loop to fluid waste contained within the down leg of the loop in Step D.

28. The method of claim 26 further comprising the following step:
Step E: monitor the flow and temperature of the fluid waste, adjusting same as needed to provide sufficient heat to the fluid waste for a sufficient period of time to accomplish the desired sterilization of the fluid waste;
wherein Step E occurs after Step A, and Steps B, C, D. and E are performed simultaneously.
